(19) United States
(12) Patent Application Publication
(10) Pub. No.: US 2007/0193423 A1
(43) Pub. Date: Aug. 23, 2007

(54) Boring spindle for a horizontal or vertical machining centre with internal power-split drive

(76) Inventor: Rolf Eckstein, Roedental (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/708,036

(22) Filed: Feb. 20, 2007

(30) Foreign Application Priority Data
Feb. 20, 2006 (DE) 10 2006 007 737.7

(51) Int. Cl. B23B 19/02

(52) U.S. Cl. 82/142

(57) ABSTRACT

The invention relates to a spindle slide for a machining centre for the machining of workpieces. The spindle slide is accommodated in a slide traversable in the vertical direction and accommodates in turn an axially traversable tool spindle. The tool spindle is driven in the direction of rotation by means of a drive and can be axially traversed by means of a drive. A gearing is provided between the tool spindle and the drive. The rotary drive of the tool spindle and the gearing are arranged in the interior of the spindle slide.

### REFERENCE TO FOREIGN PATENT APPLICATION

This application is based on German Patent Application No. 10 2006 007 737.7 filed 20 Feb. 2006, upon which priority is claimed.

### BACKGROUND OF THE INVENTION

1. Field of the Invention

The invention relates to a boring spindle which in particular is used on vertical or horizontal machining centres and which has an internal power-split drive.

2. Description of the Prior Art

A headstock having a main bearing arrangement of the spindle can be seen from the company brochure “Union Horizontal, Boring and Milling Machines and Machining Centres, model 100/110, table type” of Union Werkzeugmaschinen GmbH Chemnitz, Clemens-Winkler-StraBe 5, D-09116 Chemnitz, brochure code T-TC 10-11-9d. According to this solution, a sleeve is mounted on the spindle, which has a tool holder at the front end. The sleeve is arranged in a casing by means of rolling-contact bearings, the casing accommodating the spindle and the sleeve being driven via a belt drive. To this end, an axial section of the casing is designed as a belt pulley, around which three belts revolve. The belts are driven by a drive accommodated above the boring spindle in a housing part arranged above the spindle slide. The arrangement of this drive takes up considerable construction space and is not completely free of play with regard to rotary accuracy and the external circularity of the casing of the boring spindle.

DE 28 45 968 A1 or DD 201 818 discloses an arrangement of functional elements of a work spindle, in particular for a coordinate boring machine. This solution discloses a work spindle which is used in particular in coordinate boring machines and which, in order to realize highly precise rotary and translatory movements, is mounted and guided in a rotary and axially displaceable manner in at least two hydrostatic multi-pocket bearings arranged in the housing, or in bearings designed in another manner. Functional elements are used in order to transmit the rotary and translatory movements to a hollow work spindle. Said functional elements comprise a hollow shaft, a threaded hollow spindle and a fixed rod, which are arranged so as to project into the hollow work spindle. The rotary movement transmitted by the hollow shaft projecting telescopically into the hollow work spindle is transmitted to the hollow work spindle by positive locking. The hollow shaft connected to the main drive is mounted in a rotatable, but axially fixed manner in the housing. The translatory movement is transmitted to the hollow work spindle by the threaded hollow spindle which projects telescopically into the hollow shaft. The spindle-head-side end of the threaded hollow spindle is connected to the hollow work spindle so as to be rotatable via an axial bearing arrangement, but in an axially fixed manner. The drive-side part of the threaded hollow spindle engages in a nut which is connected to a secondary drive and is mounted so as to be rotatable in the housing, but in an axially fixed manner. The threaded hollow spindle itself is secured against rotation via positive locking and is guided in an axially displaceable manner by the rod, which in turn projects telescopically into said threaded hollow spindle and is connected to the housing in a rotationally locked and fixed manner.

According to the solution known from DE 28 45 968 A1, the torque of the main drive is transmitted by a hollow shaft, whereas the feed force of the secondary drive is transmitted via a threaded hollow spindle.

### SUMMARY OF THE INVENTION

The object of the present invention is to provide a power-split functional block in which a tool spindle, a tool drive and a gearing of at least one-stage design are arranged in a compact type of construction and which in particular is distinguished by very quiet running, low play and constant rotational rigidity.

Following the solution proposed according to the invention, a boring spindle is integrated in a spindle slide which, for example, is traversable in the horizontal direction and which in turn can be accommodated on a tool slide traversable in the vertical direction, which boring spindle comprises a hollow shaft which encloses a cylindrical electric drive whose output interacts with an at least two-stage gearing, in particular an epicyclic gearing. The epicyclic gearing preferably used is constructed in such a way that, while dispensing with a sun gear, which is conventional in epicyclic gearings, at least two, preferably three, external planet gear shafts are provided, on which a respective planet gear is accommodated. The tooth systems of the at least two planet gears arranged externally are preferably helical tooth systems and are hardened and ground for achieving very quiet running.

The epicyclic gearing used, without a sun gear, can be moved into at least two transmission stages, as a result of which at least two rotary speeds of the tool spindle can be achieved.

An overload safety device constitutes the connection between the output of the gearing, preferably designed as an epicyclic gearing, and the tool spindle. The overload safety device is preferably designed as a shrink-fit seat between the tool spindle and the output of the epicyclic gearing. The shrink-fit seat is surrounded by a ring, the outer surfaces of which are designed to run in a tapered or crowned manner. Accommodated on the outer circumferential surface of the ring enclosing the shrink-fit seat are two annular components, the inner circumference of which is designed so as to correspond to the outer contour of the ring surrounding the shrink-fit seat. The rings lying next to one another in the region of the overload safety device are prestressed against one another by means of prestressing elements, such that, firstly, the overload safety device is designed to be absolutely free of play and, secondly, starting from a point at which a slip torque defined by the prestressing is exceeded, a relative movement is made possible between the output of the gearing and the shaft accommodating the tool holder. In a manner which is especially favourable in terms of manipulation, the spindle slide of the tool spindle is provided with an access opening lying in the region of the overload safety device, such that the overload safety device is accessible from outside. Rapid release of the overload safety device and dismounting same via the front side drastically reduces the setting-up times if exchange of the tool spindle is required.

The tool spindle proposed according to the invention and accommodated in a horizontally traversable spindle slide is distinguished by constant rotational rigidity, as viewed over its cross section, in the entire adjusting region, i.e. along its entire extension path. Still further, the tool spindle comprises a gapless circumference which significantly reduces the risk of danger during operation.

In the solution proposed according to the invention for the tool spindle of a machining centre which is preferably used within the scope of production by machining processes, the gearing which transmits the torque of the drive, as a rule designed as an electric drive, to the tool spindle is made in such a way that power splitting of the output torque of the electric drive is transmitted via at least two, preferably three, tooth engagements to the tool spindle. The gearing used, via which the output torque of the electric drive is transmitted to the tool spindle, may either be designed in such a way that it merely has one transmission stage, in which case gear shifting may be dispensed with, or it may have any desired number of transmission stages.

The number of transmission stages, i.e. the speed of the tool spindle, can be predetermined at the gearing via a number of planet gears or planet pinions corresponding to the number of desired transmission stages, said planet gears or planet pinions being accommodated on planet shafts. In addition, it is of course also possible for the speed of the tool spindle accommodating the tool to be directly set at the electric drive and for it to be predetermined in this way. The tool spindle which is proposed according to the invention, and which is guided in the spindle slide in a traversable manner, has a tool holder at its end face pointing towards the workpiece to be machined. Alternatively, a tool unit which expands the functionality of the tool spindle with regard to the machining planes and machining angles may also be accommodated on this end face. Media lines via which hydraulic medium, compressed air, electrical lines and the like can be directed to the end face of the horizontally traversable spindle slide are advantageously embedded in the interior of the spindle slide in a cavity between the tool spindle, traversable in the horizontal direction, and the inner wall of the spindle slide, such that said media lines are protected from damage.

The solution proposed according to the invention offers the lowest degree of play, and very quiet running with constant rotational rigidity during the extension movement of the tool spindle from the spindle slide is ensured by the power-split drive selected.

### BRIEF DESCRIPTION OF THE DRAWINGS

The invention is described in more detail below with reference to the drawing, in which:

FIG. 1 shows an arrangement of a tool spindle known from the prior art, said tool spindle being provided with at least one longitudinal slot running in the axial direction for transmitting the rotary movement, the rotary drive being arranged outside the tool spindle,

FIG. 1.1 shows a section through the tool spindle according to the illustration in FIG. 1,

FIG. 1.2 shows an enlarged illustration of the geometry of the longitudinal slot corresponding to the illustrations in FIG. 1 and FIG. 1.1.

FIG. 2 shows a schematic illustration of the machining centre proposed according to the invention and having a horizontally traversable spindle slide, a tool spindle which can be extended from the latter, and a vertically traversable slide,

FIG. 2.1 shows a front view of the vertical slide shown in FIG. 2 and which encloses the horizontally traversable slide and the tool spindle accommodated in the latter in a traversable manner,

FIG. 3 shows a plan view on an enlarged scale of the vertical slide according to the invention,

FIG. 4 shows a longitudinal section through the spindle slide according to the invention,

FIG. 5 shows a cross section through the gearing, coupling the tool spindle to the internal electric drive, along section line V-V in FIG. 4,

FIG. 6 shows a detailed illustration of the gearing according to FIG. 4,

FIG. 7 shows the section through the gearing along section line VII-VII in FIG. 6, and

FIG. 8 shows a section through the gearing along section line VIII-VIII in FIG. 6 in a transmission stage.

### DESCRIPTION OF THE PREFERRED EMBODIMENTS

The invention is described below using the example of a machining centre which has a vertical slide which is traversable on a guide, such as a hydraulic guide for example, and on which a horizontally traversable spindle slide is accommodated. A tool spindle is incorporated in this horizontally traversable spindle slide. In addition, it is also possible for the solution, proposed according to the invention, of the spindle slide with integrated rotary drive and tool spindle extendable from the spindle slide to be arranged in the vertical direction.

The expression “tool spindle” refers below to a spindle where both a cutting tool, such as, for example, a drill or a milling head, a grinding wheel or the like, and a unit which expands the functionality of the tool spindle can be attached to the tool holder of said spindle, said unit expanding the functionality of the tool spindle to the effect that a tool accommodated on the unit can be traversed at various machining angles and in various machining planes in order to significantly expand the functionality of the machining centre equipped with it.

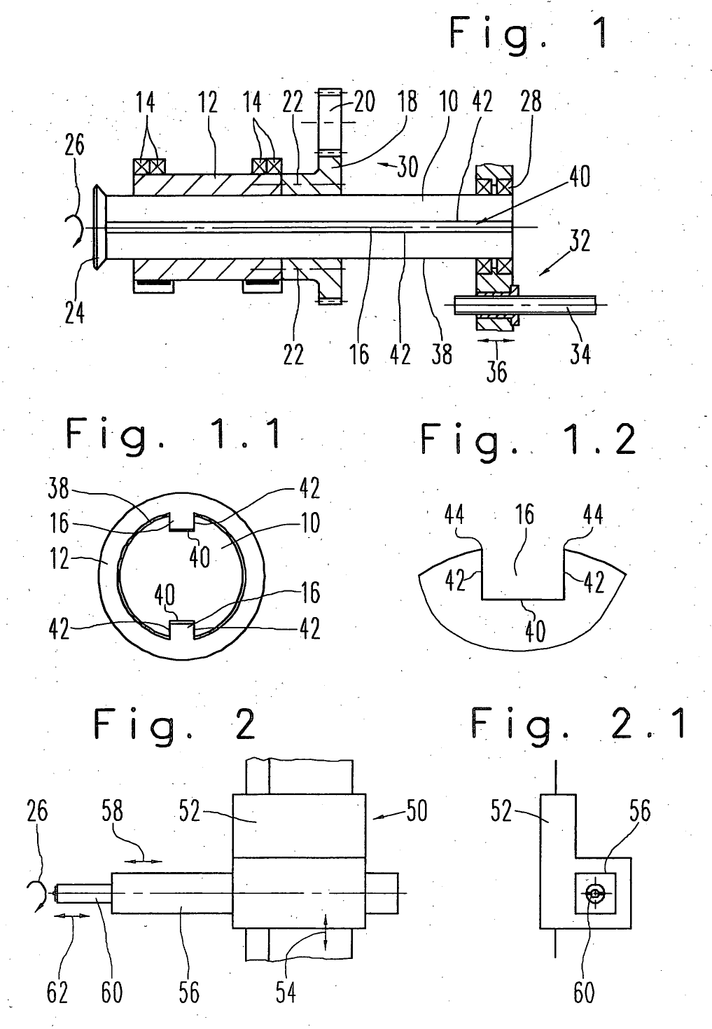

To explain the technical problem which can occur in known solutions, reference may be made to FIGS. 1, 1.1 and 1.2. FIG. 1 shows a schematic illustration of a spindle 10 which is provided with a sleeve 12 at its end accommodating a tool 24. The sleeve 12 is accommodated at its outer circumference in rolling-contact bearings 14 and is connected to a driven gear 18 via a fastening 22 (only shown schematically). The torque of a driving gear 20, which in turn is set in rotation by a drive (not shown in FIG. 1), is transmitted to the sleeve 12 via the driven gear 18. The sleeve 12 in turn transmits the torque via a spline/slot connection. The corresponding longitudinal slot is indicated in FIG. 1 by reference numeral 16. The spindle 10 is set in rotation in the direction 26 of rotation by this arrangement. At its end remote from the tool 24, the spindle 10 is mounted on a spindle bearing 28. Whereas the rotary drive 30 is introduced into the sleeve 12 via the gears 18, 20 and the sleeve 12, an axial feed is introduced via the spindle bearing 28, to which a feed drive 32 is coupled. The feed drive comprises a threaded spindle 34, the rotation of which is converted into a feed movement 36. The feed movement 36 is transmitted to the spindle 10 via the spindle bearing 28. In FIG. 1, reference numeral 40 designates the longitudinal Slot 16. The longitudinal slot 16 is defined by slot flanks 42 and slot edges 44; in this respect see FIGS. 1.1 and 1.2.

A section through the spindle according to FIG. 1 can be seen from the illustration according to FIG. 1.1, the section line passing through the sleeve.

It can be seen from the illustration according to FIG. 1.1 that the sleeve 12 for transmitting the torque received at the spindle 10 is coupled to the spindle 10 via at least two positive-locking connections which are designed as spline/slot connections. It can be seen from the illustration according to FIG. 1.1 that two opposite longitudinal slots 16 are formed on the circumference of the spindle 10, said longitudinal slots 16 each being defined by a slot base 40 and two slot flanks 42. This connection constitutes a positive-locking connection, which enables a torque to be transmitted by the sleeve 12.

It can be seen from the detailed illustration according to FIG. 1.2 that the slot flanks 42 of the longitudinal slot 16 run out at the circumferential surface of the spindle 12 in slot flanks 44. With regard to the surface pressure, the slot edges 44 are subjected to high Hertzian stresses, especially in the event of striking. The expression “striking” refers to a collision between the tool 24 accommodated on the spindle 10 and a workpiece to be machined, which often occurs with contract manufacturers and is unintentional as a rule and can be attributed to excessive feed of the boring spindle 10 or to too small a distance between the rotating tool 24 and the workpiece to be machined. The drive components which transmit the torque to the spindle 10 are loaded to a considerable degree by the torque surges occurring during “striking”. In the solution according to FIGS. 1, 1.1 and 1.2, firstly the service life of the selected spline/slot connection according to FIG. 1.1 is disadvantageous, as is the unavoidable play which occurs in the course of time between the slot flanks 42 and the splines engaging in the longitudinal slot 16. In addition, the solution according to FIGS. 1, 1.1 and 1.2 is disadvantageous in that the rotary drive 30 is arranged on the outside with respect to the spindle 10, a factor which requires additional construction space. This is of importance inasmuch as the feed drive 32 can certainly be mounted in a fixed position, but the rotary drive 30 driving the spindle 10 must always be traversed with the spindle 10, since the tool 24 at that end face of the spindle 10 which points towards the workpiece is always to be kept in rotation during the machining.

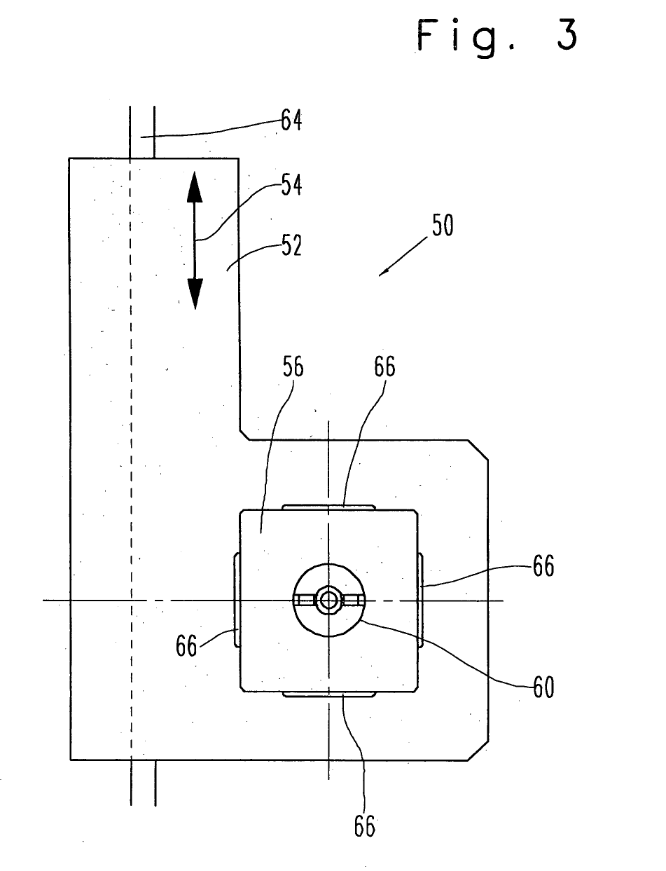

Starting from the technical problem and the disadvantages of the solutions according to the prior art, the solution proposed according to the invention is described below with reference to FIGS. 2 to 8.

The construction of a machining centre in the region of slide guides can be seen schematically from the illustration according to FIG. 2 which schematically illustrates a machining centre 50 having at least one vertical slide 52 traversable in the vertical direction 54. The vertical slide 52 may be guided in hydraulically designed guides or also in rails and is traversed in accordance with the desired machining position. A spindle slide 56 is accommodated on the vertical slide 52. The spindle slide 56 is designed in such a way that it can both retract into and extend from the vertical slide 52 in the horizontal direction 58. As a result, the machining of even longer sides of large workpieces can be achieved in one operation and in one set-up. In addition, a tool spindle 60 is accommodated in the spindle slide 56 traversable in the horizontal direction 58. With respect to the spindle slide 56 traversable in the horizontal direction 58, the boring or tool spindle 60 is likewise movable in the horizontal direction 62 relative to the spindle slide 56. The tool spindle 60 is set in rotation inside the spindle slide 56 via the drive described in more detail below.

FIG. 2.1 shows a side view of the slide configuration, shown in FIG. 2, on a machining centre. It can be seen from this view that the spindle slide 56 is guided in the vertical slide 52. The tool spindle 60 extendable in the horizontal direction 62 is in turn accommodated inside the spindle slide 56 in a traversable manner.

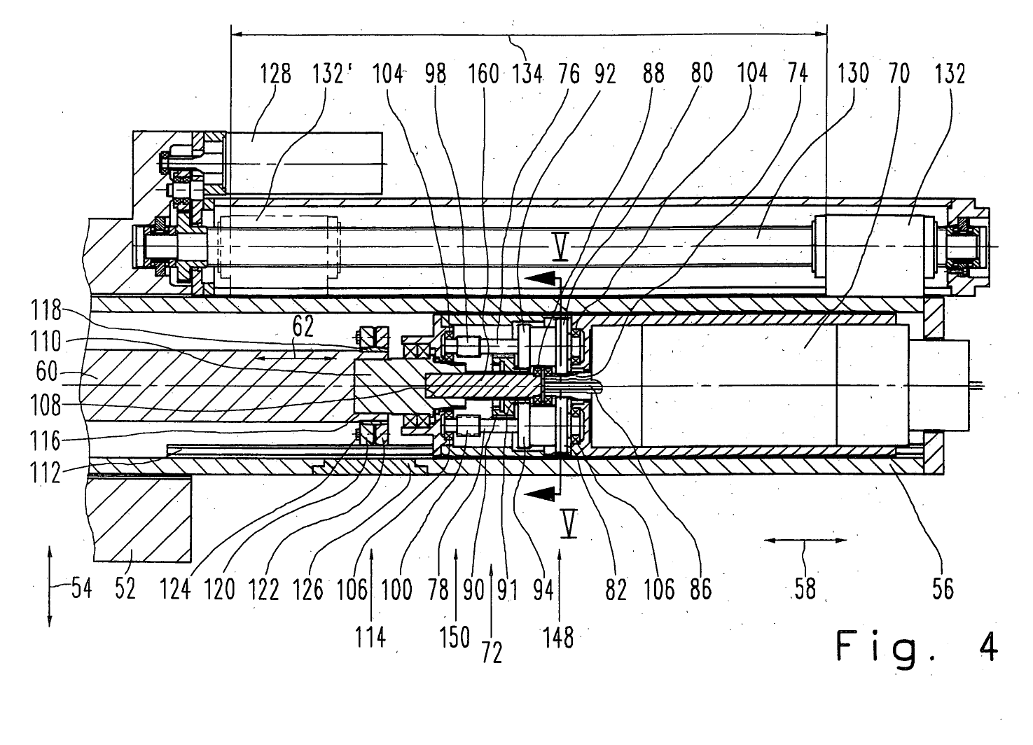

The illustration according to FIG. 3 corresponds to an illustration according to FIG. 2.1 reproduced on an enlarged scale. The spindle slide 56, which is mounted in a guide 64 of the machining centre 50, traverses in the vertical direction 54. Accommodated in the vertical slide 52 is the spindle slide 56, which in turn encloses the tool spindle 60.

The spindle slide 56 extends from the vertical slide 52 perpendicularly to the drawing plane or retracts into the vertical slide 52 perpendicularly to the drawing plane. Recesses 66 of pocket-shaped configuration are relieved at the four sides of the spindle slide 56.

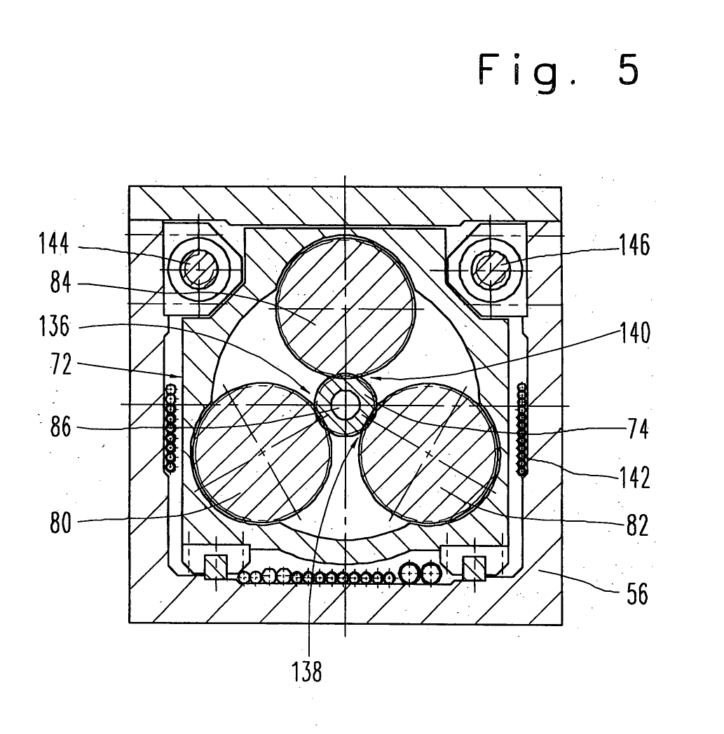

FIG. 4 shows a longitudinal section through the spindle slide which is proposed according to the invention, and which is horizontally traversable in this embodiment variant, with gearing and rotary drive integrated in the spindle slide. It can be seen from this illustration that a drive 70 for driving the tool spindle 60 is integrated in the spindle slide 56, horizontally traversable in this embodiment variant. The drive 70, preferably designed as an electric drive, is of cylindrical design and is mounted in a sleeve in the interior space of the horizontally traversable spindle slide 56. A first output pinion 74 of the drive 70 projects into a housing of a gearing 72 preferably designed as an epicyclic gearing without a sun gear. The gearing 72 is likewise arranged inside the spindle slide 56. Both the drive 70 and the gearing 72 are traversable horizontally in the interior of the spindle slide 56, such that the tool spindle 60 coupled to the output side of the gearing 72 via an overload safety device 114 is traversable in the horizontal direction 62, i.e. it can be extended from the interior of the spindle slide 56—as shown in FIG. 2. The extension length of the tool spindle 60 from the interior of the spindle slide 56 depends on the axial length and the rigidity of the spindle slide 56. The first output pinion 74 meshes with at least one first planet gear 80 and one second planet gear 82 in a first transmission stage 148 of the gearing 72 and in a further transmission stage 150. The gearing 72 designed as an epicyclic gearing without a sun gear preferably has a third planet gear, which is not reproduced in the illustration according to FIG. 4 for the sake of clarity. The first planet gear 80 is accommodated on a first planet gear shaft 76, whereas the second planet gear 82 is located on a second planet gear shaft 78. Both the first planet gear 80 and the second planet gear 82 and also the third planet gear (not shown) are accommodated in a rotationally fixed manner on their respective planet gear shafts 76, 78. Furthermore, in addition to the planet gears 80, 82, a first idler gear 92 and a second idler gear 94 are located on the planet gear shafts 76, 78. A third idler gear, which is present but is likewise not shown in FIG. 4 for graphic reasons, is accommodated in a similar manner to the first idler gear 92 and the second idler gear 94 on a third planet gear shaft, likewise not shown for graphic reasons. Finally, a first planet pinion 98 and a second planet pinion 100 are located on the first planet gear shaft 76 and the second planet gear shaft 78.

The two planet gear shafts 76 and 78, respectively, shown in FIG. 4 are rotatably mounted in rolling-contact bearings 104 on the one side in the housing of the drive 70 and are accommodated on the other side in rolling-contact bearings 106 in a housing cap of the gearing 72. Furthermore, the gearing 72 comprises an output pinion 90 which is arranged so as to be displaceable in the axial direction and which can be axially traversed, for example, along a multi-splined shaft.

It can be seen from the illustration according to FIG. 4 that both the first planet gear 80 and the second planet gear 82 mesh with the first output pinion 74 of the drive 70 in the first and second transmission stages 148, 150. In the first transmission stage 148, the output of the drive 70, starting from the first output pinion 74, runs via the at least two planet gears 80, 82 to the planet gear shafts 76, 78 and from there via at least two idler gears 92, 94 to a pinion 91 formed on the second output pinion 90 on a smaller diameter. Since the second output pinion 90, which is disengaged from the planet gears 80, 82 in the first transmission stage 148, and the pinion 91 are accommodated on a multi-splined shaft, the torque is transmitted via the pinion 91 to the multi-splined shaft and via a shaft section to an interference fit 108. At the interference fit 108, the shaft accommodating the multi-splined shaft and a gearing output shaft 110 are frictionally connected to one another. The transmission shaft 110 is accommodated in bearings 112.

The tool spindle 60 is driven in accordance with the transmission ratio which can be achieved via the first transmission stage 148.

In addition, a further transmission stage 150, indicated by the arrow provided with reference numeral 150 and pointing towards the first planet pinion 98 and the second planet pinion 100, can be realized with the gearing 72 according to the illustration in FIG. 4.

The second transmission stage 150 is reached by virtue of the fact that the second output pinion 90, on which the pinion 91 having a smaller pitch circle diameter is formed, can be traversed in the axial direction along the splined shaft 160. In the second transmission stage, there is tooth system engagement between the second output pinion 90 and the planet pinions 98 and 100 on the first planet gear shaft 76 and the second planet gear shaft 78, respectively. Since the second output pinion 90 together with pinion 91, in the second transmission stage 150, is disengaged from the idler gears 92, 94, the torque of the output 70 in the second transmission stage 150, starting from the first output pinion 74, is transmitted via the at least two planet gears 82 to the at least two planet gear shafts 76, 78 and from the latter via the at least two planet pinions 98, 100 to the axially traversable second output pinion 90 and via the splined shaft 160 and the interference fit 108 to the gearing output shaft 110 and from the latter via the overload safety device 114 to the tool spindle 60 to be driven and traversable in the horizontal direction 62.

In a modification of the gearing 72 shown in FIG. 4, at which gearing 72 the force flow in the first transmission stage 148 and in the second transmission stage 150 has been described by way of example, further transmission stages may of course also be formed, depending on the number of planet gears 80, 82, idler gears 92, 94 and planet pinions 98 and 100, by further gears of different diameters being arranged on the planet gear shafts 76, 78.

The gearing 72 described and shown in FIG. 4 constitutes an internal power-split rotary drive of the tool spindle. For graphic reasons, only two tooth engagements are shown in FIG. 4 in the first transmission stage 148 between the first output pinion 74 and the first planet gear 80 and the second planet gear 82. Similarly, for the second transmission stage 150, the situation in this case is that the axially displaced second output pinion 90 with pinion 91 is in engagement with the planet pinions 98 and 100 arranged on the first planet gear shaft 76 and the second planet gear shaft 78, respectively. The gearing 72 preferably comprises three planet gears and three idler gears and three planet pinions, which are accommodated on planet gear shafts arranged offset from one another by 120°. As a result, a gearing 72 is obtained which realizes three tooth engagements with respect to the first output pinion 74 of the drive 70, as a result of which torque transmission free of play can be achieved and very quiet running is ensured.

The output of the gearing 72 and the tool spindle 60 are advantageously coupled to one another via the overload safety device 114. The overload safety device 114 firstly comprises a shrink-fit seat 116 between the end of the tool spindle 60 and that end of the gearing output shaft 110 which is opposite said end of the tool spindle 60. In the region of the overload safety device 114, the shrink-fit seat 116 between said components 60 and 110 is enclosed by a ring 118. The ring 118 is preferably provided with sloping surfaces on its outer circumferential surface. This permits easy fitting and removal of a first clamping ring 120 and of a further clamping ring 122. The inner sides of the clamping rings 120, 122 are preferably designed to be complementary to the profile of the slope of the outer circumference of the ring 118. The first clamping ring 120 and the second clamping ring 122 are restrained against one another via clamping elements 124. When the prestressing force is applied, e.g. via clamping screws which are arranged in a uniformly distributed manner on the circumferences of the clamping rings 120, 122, a defined force or a defined torque can be set, and if said force or said torque is exceeded, the overload safety device 114 responds, i.e. the gearing output shaft 110 slips. The slopes on the outer circumference of the clamping ring 118 are preferably designed to be complementary to the slopes of the clamping rings 120 and 122 fastened to the ring 118. If “striking” occurs, the overload safety device 114 responds if a predeterminable well-defined torque is exceeded, such that the tool spindle 60 slips relative to the gearing output shaft 110, and the gearing 72 and the electric drive 70 are effectively protected from damage if “striking” occurs. In an especially advantageous manner, the overload safety device 114 is accessible from the outer side of the spindle slide 56, so that the clamping elements 124, with which the first clamping ring 120 can be restrained against the second clamping ring 122 or vice versa, can be reached very easily. In addition, the simple accessibility of the overload safety device 114 through at least one access opening 126 drastically reduces the setting-up times after “striking”, such that the production can be resumed very rapidly after a possibly requisite exchange of the tool spindle 60, since both the fitting and removal of the overload safety device 114 can be carried out very quickly in a less time-consuming manner.

Furthermore, it can be seen from the illustration according to FIG. 4 that the spindle slide 56 has a drive 128 for realizing an axial feed. The axial feed of the spindle slide 56 is effected along a maximum feed travel which is identified in the illustration according to FIG. 4 by reference numeral 134. The drive 128 drives a feed spindle 130 via a gearing (not shown in FIG. 4). A feed body 132 which is firmly connected to the housing of the spindle slide 56 runs on the feed spindle 130, which is preferably designed as a threaded spindle. A zero position of the feed body 132 is designated by reference numeral 132. In this position, the spindle slide is in its retracted position, i.e. for the most part retracted into the vertical slide 52. In the position designated by reference numeral 132′ and shown by broken lines in FIG. 4, the feed body 132 is in its position realizing a maximum feed path 134. Of course, positions lying between the two positions 132, 132′ shown can be approached in an infinitely variable manner by means of the drive 128.

It becomes clear from the illustration according to FIG. 5 that the first output pinion 74 of the drive 70 meshes with both the first planet gear 80 and the second planet gear 82 and also with the third planet gear 84. This means that the torque of the first output gear 74 is transmitted via first, second and third tooth engagements 136, 138 and 140, shown in FIG. 5, to the planet gear shafts 76 and 78 (cf. the illustration according to FIG. 4, except for a third planet gear shaft, which is not shown). The output arrangement, shown in FIG. 5, of the gearing 72 consists in each of the two transmission stages 148 and 150, respectively, explained in connection with FIG. 4, and also in further transmission stages. The three tooth engagements 136, 138 and 140 ensure power splitting of the output torque of the drive 70, a factor which contributes to excellent quiet running and to running of the tool spindle 60 free of play, irrespective of the selected transmission stage 148 or 150. It becomes clear from the sectional drawing shown in FIG. 5 that a compact construction of a motor/gearing configuration driving the tool spindle 60 can be achieved via the three tooth engagements 136, 138, 140, in the case of helical planet gears 80, 82, 84 and a first drive pinion 74, also by hardening of the tooth flanks.

It can also be seen from FIG. 5 that media lines 142 run on the base or on a side wall of the horizontally traversable spindle slide 56, as a result of which the media lines 142 are protected against damage from the outside. The extension movement of the tool spindle 60 from the spindle slide 56 in the horizontal direction is effected via threaded spindles 144, 146.

Even though not shown in FIG. 5, reference is expressly made to the fact that the tooth engagements 136, 138 and 140 in FIG. 5 prevailing between the planet gears 80, 82, 84 and the first output pinion 54, also prevail at the other tooth system components of the planet gearing 72, which is preferably without a sun gear. Thus, the three tooth engagements explained in connection with the planet gears 80, 82 and 84 also exist between the second output pinion 90, which is axially displaceable on the splined shaft 160, for the case where said output pinion 90 meshes in the second transmission stage 150 with the planet pinions 98, 100 and with the third planet pinion (not shown). Similarly, in the first transmission stage 148, the idler gears 92, 94 and the third idler gear not shown in FIG. 4 mesh with the pinion 91 which is formed on the output pinion 90 accommodated on the multi-splined shaft 160 in an axially displaceable manner.

It is therefore ensured that the torque of the drive 70 is transmitted simultaneously to the tool spindle 70 via three tooth engagements 136, 138 and 140 in each of the transmission stages 148 and 150 described in connection with FIG. 4.

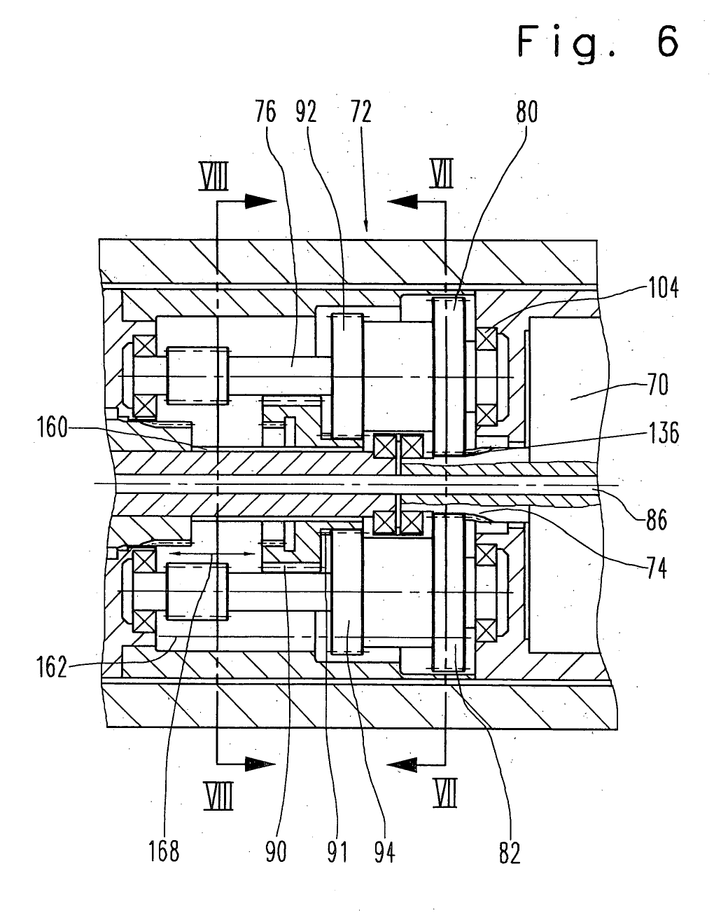

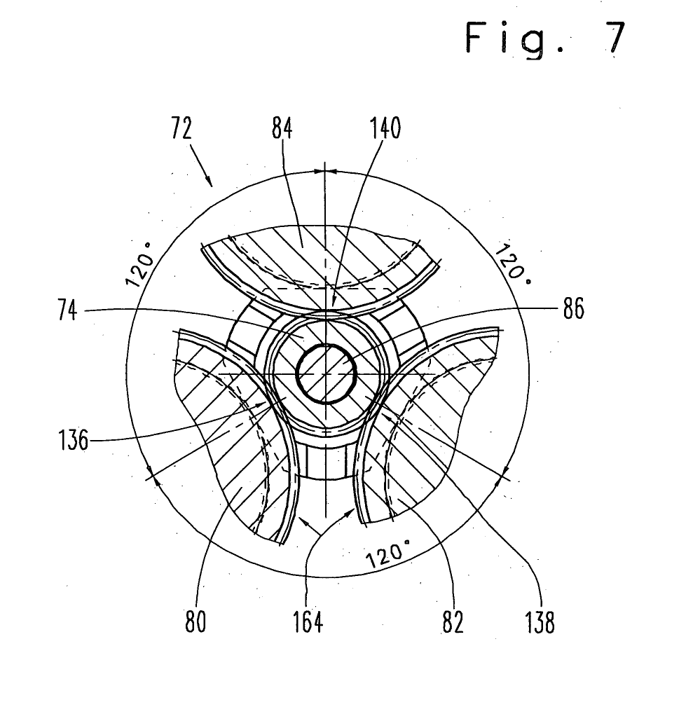

It can be seen from the illustration according to FIG. 6 that a through shaft 86, which is designed as a splined shaft, passes through the drive 70. Mounted in turn on the through shaft 86 is the splined shaft 160 which is explained in connection with FIG. 4 and on which the second output pinion 90 together with pinion 91 formed thereon is in turn accommodated in such a way as to be displaceable in the axial direction. The axial traverse path of the second output pinion 90 together with the pinion 91 connected thereto is designated by the double arrow 168 in the illustration according to FIG. 6.

Furthermore, it can be seen from the illustration according to FIG. 6 that the first output pinion 74 of the drive 70 meshes with the first planet gear 80 mounted on the first planet gear shaft 76. The tooth engagement is designated by reference numeral 136. Furthermore, the first output pinion 74 of the drive 70 meshes with the second planet gear 82, indicated by the tooth engagement designated by 140 in FIG. 5. The torque of the drive 70 is therefore transmitted by the first output pinion 74 and the first and the second planet gear 80, 82 to the planet gear shafts 76, 78, of which only the first planet gear shaft 76 is shown in the sectional illustration according to FIG. 6. Mounted on the planet gear shaft 76 is the first idler gear 92, which meshes with the pinion 91 attached to the second output pinion 90. The same applies to the second idler gear 94, which according to the illustration in FIG. 6 meshes with the pinion 91 on the second output pinion 90. The gearing 72 is filled with lubricant, the level of which in the housing of the gearing 72 is indicated by the reference numeral 162. Projecting into the lubricant is, for example, the circumference of the second planet gear 82, such that the lubricant, is transferred via the tooth engagement 140 to the first output pinion 74 and from the latter via the further tooth engagement 136 to the first planet gear 80.

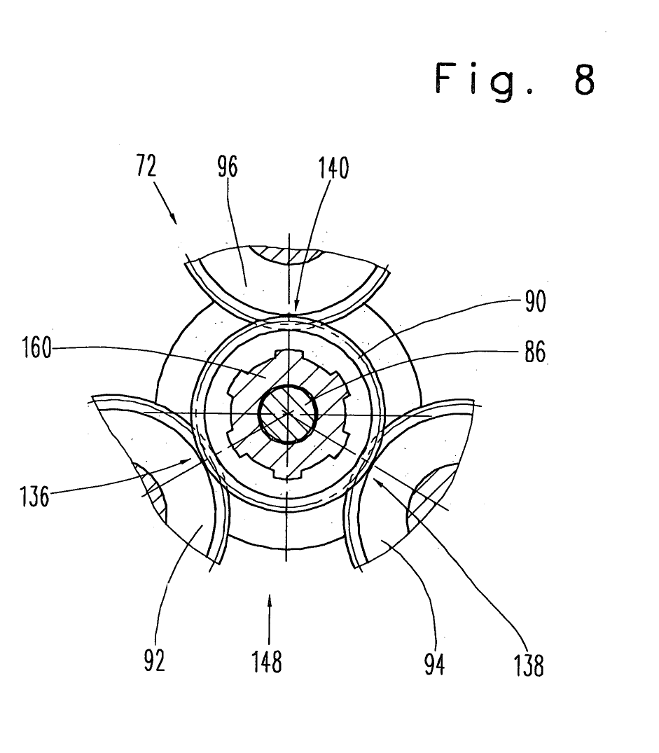

FIG. 7 shows a section through the gearing according to the illustration in FIG. 6 along section line VII-VII. FIG. 7 shows that the gearing 72, in the region of the first output pinion 74, has the first planet gear 80, the second planet gear 82 and the third planet gear 84. Due to this circumstance, three tooth engagements 136, 138, 140 are obtained via which the power transmitted from the drive 70 to the first output pinion 74 is split in the gearing 72. Following the arrangement of the planet gears 80, 82, 84, the tooth engagements 136, 138 and 140 lie offset from one another at an angle of 120°. The three planet gears 80, 82 and 84 are preferably helical, which firstly lengthens the effective contact surface during the tooth engagement with the first output pinion 74 and which furthermore has a positive effect on the quiet running of the gearing 72. The tooth flanks of the first output pinion 74 and also of the planet gears 80, 82 and 84 shown in FIG. 7 are preferably case-hardened and are designed with a very high surface quality. This otherwise applies in the same way to the teeth of the output pinion 90 with pinion 91 formed thereon, to the idler gears 92, 94 and to the planet pinions 98 and 100 accommodated on the planet gear shafts 76, 78 shown in FIG. 4. It is expressly pointed out that the planet gearing 72—even though not shown in all the figures—has three planet gears 80, 82, 84, three idler gears 92, 94, 96 and consequently three planet gear shafts and three planet pinions 98, 100, 102 accommodated on the latter.

According to FIG. 8, the idler gears 92, 94, 96 are in engagement with the second output pinion 90, on which the pinion 91—not shown in FIG. 8 for graphic reasons—is formed. The second output pinion 90 displaceable in the axial direction 168 and mounted on the splined shaft 160 is in mesh and has three tooth engagements 136, 138 and 140, such that power splitting of the torque delivered to the first output pinion 94 by the drive is also effected in this section plane. The through shaft 86 (cf. illustration according to FIG. 4 and FIG. 6) passes through the splined shaft 160. In the illustration according to FIG. 8, the splined shaft 160 comprises six splines which each project in a raised manner above its surface and which engage in longitudinal slots formed correspondingly on the axially displaceable second output pinion 90. Depending on the number of transmission stages into which the gearing 72 can be shifted, a number of planet pinions or idler gears corresponding thereto are provided in the gearing 72.

The foregoing relates to preferred exemplary embodiments of the invention, it being understood that other variants and embodiments thereof are possible within the spirit and scope of the invention, the latter being defined by the appended claims.

1. In a spindle slide for a machining centre for the machining of workpieces, which spindle slide is accommodated in a traversable manner in a further traversable slide and accommodates an axially traversable tool spindle which is driven in the direction of rotation by means of a drive and can be axially traversed by means of a drive, and a gearing between the tool spindle and the drive, the improvement wherein the rotary drive the gearing and the tool spindle form a unit which as such is movable axially in the interior of the spindle slide.

2. Spindle slide according to claim 1, wherein the further traversable slide is traversable in the horizontal direction or in the vertical direction.

3. Spindle slide according to claim 1, wherein the gearing is designed as a power-split epicyclic gearing and has at least one transmission point for the drive torque of the drive.

4. Spindle slide according to claim 3, wherein the gearing preferably comprises three transmission points for the drive torque of the drive.

5. Spindle slide according to claim 3, wherein the at least one transmission point for the drive torque of the drive comprises tooth engagements of at least two planet gears with a first drive pinion of the drive.

6. Spindle slide according to claim 3, wherein the power-split epicyclic gearing is designed without a sun gear and realizes at least two transmission stages.

7. Spindle slide according to claim 4, wherein the preferably three transmission points comprises tooth engagements of three planet gears with a first output pinion of the drive.

8. Spindle slide according to claim 4, wherein the preferably three transmission points comprises tooth engagements of three planet gears with a first output pinion of the drive and wherein transmission of the drive power of the drive in the first transmission stage is effected from the first output pinion via the planet gears and idler gears to a pinion formed on the second output pinion.

9. Spindle slide according to claim 4, wherein the preferably three transmission points comprises tooth engagements of three planet gears with a first output pinion of the drive and wherein the transmission of the drive power of the drive in the second transmission stage is effected from the first output pinion via the planet gears and planet pinions to a second output pinion.

10. Spindle slide according to claim 8, wherein the second output pinion and the pinion comprise one component which is displaceable in the axial direction on a multi-splined shaft.

11. Spindle slide according to claim 9, wherein the second output pinion and the pinion comprise one component which is displaceable in the axial direction on a multi-splined shaft.

12. Spindle slide according to claim 1, further comprising an overload safety device arranged between the tool spindle and the output side of the gearing.

13. Spindle slide according to claim 12, wherein the overload safety device is accessible via at least one access opening formed along a horizontal traverse path of the tool spindle on the spindle slide.

14. Spindle slide according to claim 13, wherein the overload safety device comprises a shrink-fit seat between the tool spindle and a transmission body constituting the output of the gearing.

15. Spindle slide according to claim 14, wherein the overload safety device comprises a ring which encloses the shrink-fit seat and on which a first and a second clamping ring are restrained against one another by means of releasable clamping elements.

16. Spindle slide according to claim 8, comprising three tooth engagements between the first output pinion and the planet gears and between the idler gears and the pinion in the first transmission stage of the gearing, and three tooth engagements between the first output pinion and the planet gears and between the planet pinions and the second output pinion in the second stage of the gearing.

17. Spindle slide according to claim 9, comprising three tooth engagements between the first output pinion and the planet gears and between the idler gears and the pinion in the first transmission stage of the gearing, and three tooth engagements between the first output pinion and the planet gears and between the planet pinions and the second output pinion in the second stage of the gearing.

18. Spindle slide according to claim 1, wherein media lines run in the interior of the spindle slide to the workpiece-side end face of the latter, at which end face a tool holder is provided which serves to accommodate a tool or to accommodate a unit expanding the functionality of the tool spindle.

19. Spindle slide according to claim 1, wherein the spindle slide is traversable in an infinitely variable manner via at least one feed drive along its feed path between an end position of a feed body and a maximum position of the feed body.
